(19) United States
(12) Patent Application Publication
(10) Pub. No.: US 2003/0089439 A1
(43) Pub. Date: May 15, 2003

(54) Tread pattern for a radial carcass tire

(76) Inventor: Philippe Thiebaud, Beaumont (FR)

Correspondence Address: BAKER & BOTTS, 30 ROCKEFELLER PLAZA, NEW YORK, NY, 10112

(21) Appl. No.: 10/014,395

(22) Filed: Nov. 13, 2001

(30) Foreign Application Priority Data
Nov. 13, 2001 (FR) 00/14674

(51) Int. Cl. B60C 11/117

(52) U.S. Cl. 152/209.17

(57) ABSTRACT

A tread for a tire having a preferred direction of travel has a plurality of tread pattern blocks, the upper faces of which are intended to come into contact with the roadway during travel of the tire. The tread pattern blocks are provided with a plurality of wells of section S and of depth H, each block being divided into a front section and a rear section by a median plane Pv perpendicular to the upper contact face of the block and to the longitudinal direction of the tread and passing through the center of mass G of the contact face of the block when new. The front section has a leading edge and the rear section has a trailing edge. This tread is characterized in that, when new and for each tread pattern block which is provided with wells, the volume of all the wells located in the front section of the block is greater than the volume of all the wells located in the rear section of the block.

### BACKGROUND OF THE INVENTION

The invention relates to tread patterns for tires and more particularly to treads for tires having a preferred direction of travel and intended in particular for use on heavy vehicles.

Experience shows that for treads for radial carcass tires for heavy vehicles comprising a plurality of blocks defined by grooves of circumferential and transverse general orientation, these blocks are subjected to sawtooth wear (so-called irregular wear, in that it develops preferentially in the vicinity of an edge of said blocks). This type of wear is particularly great on the treads of tires mounted on the driving axles of the vehicle, whether in individual or in twin mounting. By definition, a tread pattern block comprises an upper face intended to come into contact with the roadway during travel of the tire and lateral faces defining the grooves, each intersection of a lateral face with the upper face forming a ridge. The edge of the block which is first to enter the contact zone is called the leading edge: this edge may be formed of one or more ridges, the lateral face(s) defined by these ridges forming the leading wall. The edge of the block which is last to emerge from the contact zone is called the trailing edge and the lateral face to which it belongs is called the trailing wall of the block.

The irregular (sawtooth) wear which is mentioned here is manifested by greater wear located on the contact face in the vicinity of the trailing edge.

To reduce this irregular sawtooth wear which is observed for tires fitted in particular on the driving axles of a heavy vehicle, there has been proposed in European Patent EP 0485778 a tread pattern comprising a plurality of blocks separated from each other by grooves of longitudinal and transverse orientation. One variant of embodiment set forth in this patent consists in providing for the faces of the blocks defined by the transverse grooves to form different angles (positive for the leading wall, negative—undercut—on the trailing wall) with a direction perpendicular to the running surface.

It has been observed that a positive taper angle on the leading wall was beneficial to the irregular wear and mainly to the development thereof because, though slightly more pronounced wear appears on the trailing edge from the first kilometers onwards, this wear is then very regular over the entire block, whereas for tread patterns not having a dissymmetrical taper between the leading wall and trailing wall the wear is irregular from the first kilometers onwards and is greatly amplified throughout the period of use of the tire.

However, this improvement in the irregular wear performance is accompanied by substantial degradation of the noise performance measured in a running test under torque on a vehicle (test described in Standard ISO 362 and Directive 92/97/EEC).

With the development of new high-powered heavy vehicles equipped with a hydraulic retarder, a need has arisen to develop new tread patterns which reduce the irregular wear (measured as the maximum difference in wear obtained between the trailing edge and the leading edge) without for all that increasing the average rate of wear (evaluated as the total loss of material per kilometer traveled) while not resulting in an increase in the travelling noise under torque in particular in the ISO 362 test.

### SUMMARY OF THE INVENTION

The present invention is directed at producing a tread for a radial carcass tire intended to be fitted on the driving axle of a heavy vehicle which reduces the difference in wear between the leading edge and the trailing edge without reducing the wear life performance. The present invention is also directed at a directional tire having a radial carcass reinforcement for heavy vehicles having a tread according to the invention.

The tread according to the invention has a preferred direction of travel and comprises a plurality of tread pattern elements (in the form of blocks and/or slices of rubber), which are defined by cutouts of circumferential and transverse general orientation, each block having an upper contact face and lateral faces, the intersection of each lateral face with the upper face forming a ridge, the ridge(s) which is (are) first to come into contact forming the leading edge of the element, the ridge(s) which is (are) last to emerge from the contact forming the trailing edge of the block; furthermore, a plurality of tread pattern elements comprises a plurality of wells of section S and of depth H which open on to the contact face of each of said elements; each element being divided into a front section and a rear section by a virtual median plane Pv, said median plane Pv being perpendicular to the upper contact face of the element and to the longitudinal direction of the tread and furthermore passing through the center of mass G of the contact face of the element when new, the front section comprising the leading edge and the rear section comprising the trailing edge.

The tread according to the invention is characterized in that, when new and for each tread pattern element which is provided with wells, the volume Vpa of all the wells located in the front section of the tread pattern element is greater than the volume Vpf of all the wells located in the rear section of said element.

“Cutout” is understood to mean either a groove, that is to say a recess made in the rubber of the tread, this recess having an average width greater than or equal to 2 mm, or an incision, that is to say a recess of average width of less than 2 mm.

“Well” is understood to mean a hole of small section opening on to the contact face and extending over part of the thickness of the tread; these wells may be formed in particular at the time of molding the tread by means of molding elements mounted on the mould for said tread.

The tread according to the invention is said to have a preferred direction of travel since its presence on a tire imparts to said tire a preferred direction of travel which may be marked on one of the sidewalls of said tire; this direction of travel may be inherent in the tread pattern without the presence of the wells as formed in the tread pattern according to the invention.

In the event that at least one well were present both in the front section and the rear section of a tread pattern element (by an appropriate inclination relative to the upper face of the element), part of the volume of this well is included in the calculation of the total volume Vpa and the remainder in the total volume Vpf.

The difference in the volumes of the wells produced in that part of each element which is located between the median plane Pv and the leading edge and that part which is located between the median plane and the trailing edge imparts to each element a dissymmetry between the entry and exit points to and from the contact; all the elements comprising wells have the same direction of dissymmetry, namely a well volume which is greater on the side of the leading edge, which is an essential characteristic of the invention. This original feature imparts a directional nature to the tread pattern or alternatively reinforces the directional nature when the tread pattern is directional by the particular arrangement of the elements composing said tread pattern. Of course, all the tread pattern elements comprising wells must have the same direction of dissymmetry without for all that having to comprise the same number of wells or wells of the same dimensions.

Preferably, the volume Vpf is at most equal to 30% of Vpa (in the examples of embodiment described Vpf is zero or virtually zero).

Contrary to the teaching of certain documents (see patent application JP92-85108) which advocate a preferred distribution of the wells on the sections which wear most quickly, and surprisingly it has been noticed that the presence of a larger volume of wells of small section on the front section of the tread pattern elements made it possible substantially to reduce the difference in wear between the leading edge and the trailing edge by reducing the rate of wear on the trailing edge without adversely affecting the average rate of wear of the elements.

In the case of a tread pattern comprising at least one rib defined by grooves of circumferential or longitudinal general orientation, said rib furthermore being provided with a plurality of incisions (that is to say cutouts of a width less than 2 mm) of transverse general orientation defining a plurality of tread pattern elements in the form of blocks or slices of rubber, it is also advantageous to provide for the presence of wells in a dissymmetrical volume distribution in a plurality of these rubber slices. Each slice of rubber comprises a lateral leading face intersecting the contact face along a leading edge corresponding to the edge which is first to come back into contact during the travel of the tire provided with this tread. Each slice comprises a trailing edge corresponding to the edge of the slice which is last to emerge from the contact zone.

A slice of rubber is a block, the length of which measured in the longitudinal direction of the tread is less than the length of this block in the transverse direction.

In this latter case, it is advantageous to provide for a plurality of slices of rubber of one rib to be provided with wells which open on to the contact face of these slices, each slice being divided into a front section and a rear section by a virtual median plane Pv, said median plane Pv being perpendicular to the upper contact face of the slice of rubber and to the longitudinal direction of the tread and furthermore passing through the center of mass G of the contact face of the slice when new, the front section comprising the leading edge and the rear section comprising the trailing edge.

The tread according to the invention is characterized in that, when new and for each rubber slice which is provided with wells, the volume Vpa of all the wells located in the front section of the slice is greater than the volume Vpf of all the wells located in the rear section of the slice.

In addition to the improvement in irregular wear and travelling noise under torque, a substantial improvement in grip was observed due to the presence of additional ridges on the surface of each block, these ridges being formed by the intersections of the wells with the contact face of the block when new and as long as these wells are present in the tread.

Advantageously, and in accordance with preferred arrangements:

the blocks or slices have positive taper angles on the leading face;

the blocks or slices have positive taper angles on the leading face which are greater than the taper angles of the trailing faces;

the blocks or slices have undercut trailing faces (negative angle);

the wells have depths which may vary according to the position in the blocks or slices and, in particular, the wells have depths which decrease gradually towards the trailing edge either starting from the leading edge or starting from a distance measured from the leading edge;

the wells have the same depth and the density of said wells decreases from the leading edge towards the trailing edge;

the wells have sections of between 0.2 and 12 mm²; of course, a well may have a geometry of non-circular section, such as, for example, an elliptical geometry;

the wells have depths at least greater than 5 mm; they may be between 5 and 25 mm;

the average number of wells measured on the upper contact face of each block or slice is less than or equal to 15 per square centimeter and preferably between 3 and 10 per square centimeter;

the wells end in a widened section to limit the problems of endurance at the bottom of the wells.

The person skilled in the art, according to the desired objects may of course combine the preferred arrangements mentioned above with each other.

The invention will now be described in non-limitative manner with reference to the accompanying drawings showing embodiments of the invention:

### DESCRIPTION OF THE DRAWINGS

FIG. 1 shows, in a plan view, a tread pattern according to the invention;

FIG. 2 is a sectional view along II-II through a block of the tread pattern shown in FIG. 1;

FIGS. 3, 4, 5 and 6 show, viewed in section, variant embodiments of tread patterns according to the invention;

FIG. 7 shows, in a plan view, another variant of a tread pattern according to the invention;

FIG. 8 shows a section along the line VIII-VIII of a block of the tread pattern shown in FIG. 7;

FIG. 9 shows, in a plan view, a tread having a plurality of ribs provided with incisions;

FIG. 10 shows another variant of a tread pattern according to the invention comprising ribs and blocks.

### DESCRIPTION OF PREFERRED EMBODIMENTS

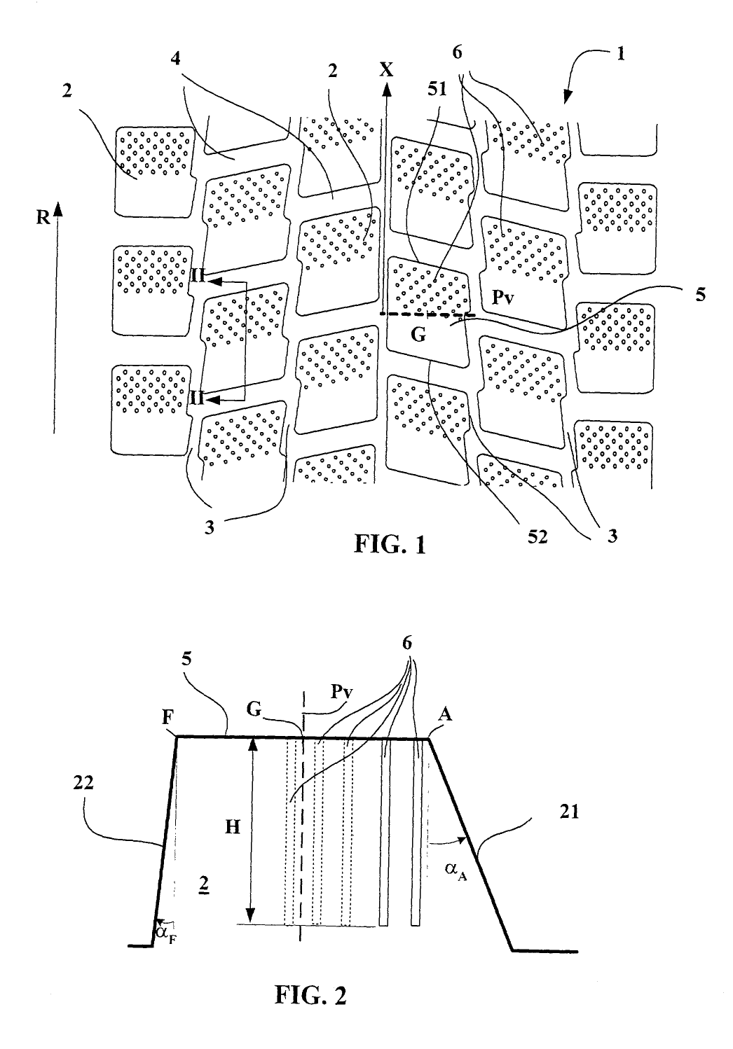

FIG. 1 shows, in a plan view, a tread 1 when new for a heavy-vehicle tire of dimension 315/80 R 22.5 comprising six rows of blocks 2 arranged so as to impart a direction of travel to said tire (symbolized by the arrow R in the drawing). The blocks 2 are defined by grooves 3 of circumferential orientations of rectilinear general shape and transverse grooves 4 connecting said circumferential grooves 3. Ridges limit the upper face 5 of each of the blocks 2 visible in FIG. 1 and intended to come into contact with the roadway during travel. The ridge located at the front of the block constitutes the leading edge 51 of the block since it is the first of the ridges of said block to come into contact with the roadway during travel; the longitudinally opposed ridge is the last to emerge from the contact and forms the trailing edge 52 of the block 5. The straight line, marked Pv, which passes through the point G, representing the center of mass of the upper contact face 5 (and corresponding to the center of inertia of this surface), represents the trace on the contact face of a median plane Pv perpendicular to the upper contact face 5 of the block 2 and to the longitudinal direction X of the tread.

A plurality of wells 6 is provided which open on to the contact face 5 of each block 2 when new; all the wells 6 have the same dimensions, namely:

circular section of a diameter of 2 mm;

depth of 10 mm;

average number of wells per square centimeter of surface: 4.5;

axis of the wells: substantially perpendicular to the contact face.

The wells are distributed over seven lines substantially parallel to the leading edge 51 and placed in a staggered configuration. Furthermore, virtually all the wells are present on the front section of each block and the volume Vpa is very great compared with the volume Vpf (Vpf here represents at most less than 9% of Vpa). The same tread pattern without the wells corresponds to a tire tread pattern sold under the mark XDE2.

FIG. 2 shows a view in section along the line II-II of a block 2 of the tread pattern shown in FIG. 1; this block 2 has a leading face 21 and a trailing face 22 intersecting the upper face 5 respectively along the leading and trailing edges, the traces of which in the plane of FIG. 2 are marked by the points A and F. The trailing face 22 forms with a line perpendicular to the upper contact face 5 an angle α_{F} less than the angle α_{A} formed by the leading face relative to the same perpendicular line. A plurality of wells 6 opening on to the contact face 5 and extending over the same depth H is distinguished, a majority of said wells 6 being between the plane Pv passing through the point G which is the center of mass of the contact face and the leading face 21.

A comparative running test was carried out with 315/80 R 22.5 tires inflated and loaded to rated conditions (pressure: 8 bar; load: 3000 daN). Control tires of tread pattern XDE2 (without wells) were compared with tires of the same dimension having a tread in accordance with the invention and corresponding to the description given with respect to FIG. 1. The wear running was carried out with high-powered vehicles equipped with a hydraulic retarder travelling at an average speed of 100 km/h on a circuit which reproduced running conditions of motorway type.

Results obtained:

irregular “sawtooth” wear: the difference in wear between the leading edge and the trailing edge, which is equal on average to 2.5 mm for a given mileage on the control tires, is reduced to 2 mm for the same mileage with the tires according to the invention;

regular wear: improvement of 10% with the tread pattern according to the invention (which means that a tread pattern according to the invention makes it possible to cover a mileage increased by 10% compared with that permitted by a tire of the prior art).

Furthermore, a significant improvement is noted, that is to say an improvement on average greater than 1 dB(A), in terms of noise under torque measured under the test conditions of European Directive CEE 92/97 (pressure equal to 8 bar and load of 1000 daN) corresponding to Standard ISO 362.

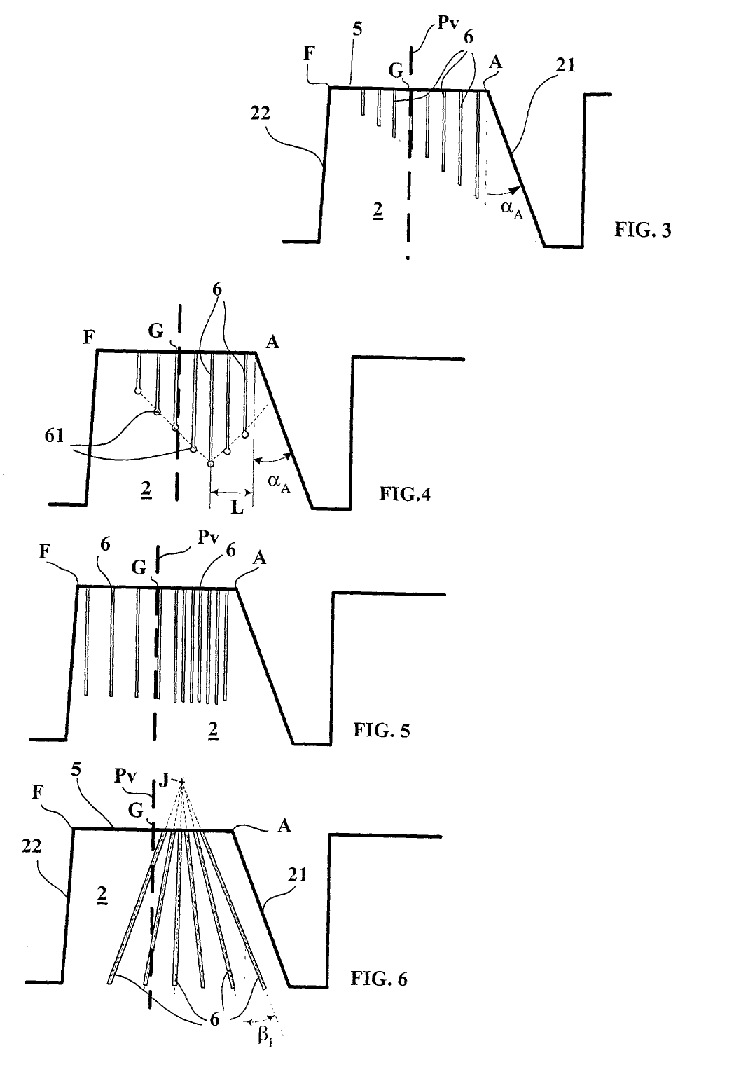

In FIGS. 3, 4, 5 and 6 there are shown, viewed in section in the thickness of variants of treads according to the invention, various embodiments of wells in tread-pattern blocks. All these sections are taken in a plane perpendicular to the contact face of the new tire and containing the longitudinal direction. For convenience, the same references as those already used with FIGS. 1 and 2 are retained for all these figures.

In FIG. 3, the section through a block 2 shows that this block comprises a leading face 21 forming a positive taper angle α_{A} with a direction perpendicular to the contact face 5; the intersection of the leading face 21 with the contact face 5 corresponds to point A in FIG. 3. The trailing face 22 of this block has a zero taper angle (it is perpendicular to the contact face) and intersects the contact face 5 at F in this FIG. 3. The trace of the median plane Pv on the section plane is shown by a straight line Pv in broken lines; the front section of the block corresponds to the section between Pv and the leading face. In this variant, the entire block is provided with a plurality of wells 6 of section of between 0.2 and 12 mm², these wells having depths which decrease regularly from the leading edge towards the rear section of the block located between Pv and the trailing edge, the wells of maximum depth being located in the front section of the block.

In another variant, in FIG. 4, which is substantially identical to that of FIG. 3, the deepest wells 6 are located at a distance L from the leading edge (wells of lesser depth are arranged on either side of this position) in order to modulate the pressures in the region of the block close to the leading edge.

In another variant, in FIG. 5, all the wells 6 have the same section and the same depth, but the number of wells per unit of surface area is greater on the front section of the block 2 than on the rear section.

In the variant shown in FIG. 6, the wells 6 have rectilinear axes forming angles βᵢ, other than zero, with a line perpendicular to the contact face 5 when new. In this variant, the wells 6 in the vicinity of the leading face 21 have their axes substantially parallel to said face, while the other wells form angles which differ from each other (all the axes of the wells here are convergent at a virtual point J located to the outside of the block).

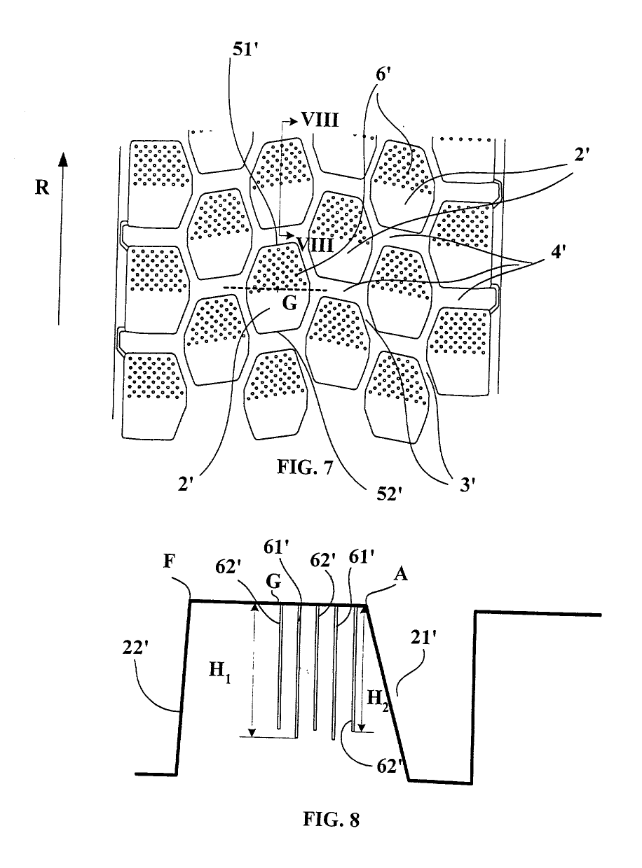

FIG. 7 shows, in a plan view, a tread when new for a heavy-vehicle tire of dimension 315/80 R 22.5 comprising six rows of blocks 2′ arranged substantially in a staggered configuration. The blocks 2′ are defined by zigzag grooves 3′ of circumferential orientations and transverse grooves 4′ connecting said circumferential grooves. Contrary to the tread pattern shown in FIG. 1 and with the exception of the wells in the two variants, this latter tread pattern is not directional per se (the arrow R in the figure indicates the recommended direction of rotation).

On the front section of each block 2′ there is formed, at the time of molding of the tread, a plurality of wells 6′ of circular section of a diameter of 2 mm which are aligned along lines parallel to the leading edge 51′, the wells 6′ being placed in a staggered configuration from one line to its neighbor(s). Furthermore, and to avoid an excessively sudden transition at the moment of the disappearance of all the wells 6′ after wear of the tread, wells 62′ of certain lines have a depth H₂ equal to 10 mm, while the wells 61′ of the neighboring lines have a depth H₁ equal to 12 mm. In combination with the presence of these wells 6′ on the front section of the blocks 2′, the leading face 21′ forms a positive taper angle with a line perpendicular to the contact face of the block when new. This positive taper, equal to 15°, is extended over the two lateral faces, gradually diminishing towards the trailing face 22′ to remain substantially constant, and equal to 3°, over a part of the lateral faces and the trailing face.

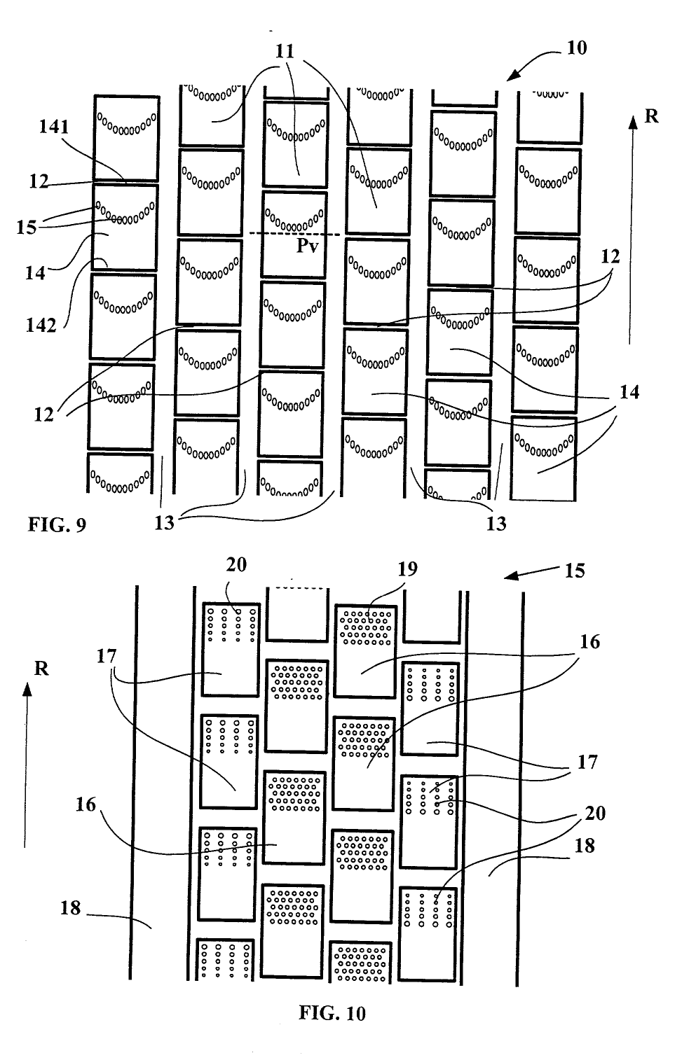

Another tread variant according to the invention is shown in FIG. 9. In this FIG. 9, which shows in plan view part of a tread 10, there are distinguished six longitudinal ribs 11 defined by circumferential grooves 13. Each rib is provided with a plurality of incisions 12 of width equal to 0.6 mm oriented in the transverse direction. On each rib 11, the incisions define blocks of rubber 14 which, taking into account the direction of mounting of the tire provided with this tread, comprise a leading edge 141 and a trailing edge 142.

To reduce the irregular wear of the blocks of rubber 14 which develops preferentially on and in the vicinity of the trailing edge 142 while substantially reducing the noise under torque, a plurality of wells 15 of depth substantially equal to the depth of the transverse incisions 12 is produced during the molding of the tread; these wells open on to the contact face of the block of rubber 14 (face in contact with the roadway) and are distributed along a circular line, the concavity of this line being turned towards the leading edge 141. Furthermore, all the wells of one and the same block are located between the leading edge 141 and a plane Pv passing through the center of mass of the contact face of this slice and perpendicular to said face (marked by its trace Pv on one of the slices shown). In the present case, all the blocks of rubber 14 have the same distribution of wells 15. The arrow R indicates the recommended direction of rotation when this tread is fitted on a tire.

In another variant, at least the tread pattern elements located in the median region of the tread are provided with wells. As shown in a plan view in FIG. 10, a tire tread 15, having a recommended direction of rotation and marked by the arrow R, comprises two longitudinal ribs 18 surrounding four rows of blocks 16, 17 defined by grooves of circumferential and transverse general orientation. In this variant, the blocks 16 of the two central rows are provided with a plurality of wells 19 of the same dimensions (section and depth) arranged between what is called a leading edge and a plane passing through the center of mass of the contact face of the block and perpendicular to said face; these wells 19 are arranged on a plurality of lines and staggered from one line to the other. The blocks 17 of the intermediate rows (between the central rows and the ribs) are provided with a plurality of wells 20 arranged along transverse lines substantially parallel to the leading edges of the elements, the wells of each line having different sections which decrease or increase from the leading edge to the trailing edge.

Preferably, in any one of the variants described, at least one well may be provided, the main axis of which has an inclination, relative to a line perpendicular to the contact face, which is not constant in the thickness of the tread.

The invention is not limited to the examples described and shown, and various modifications can be made thereto without departing from the scope thereof; in particular, the person skilled in the art is able to effect a dimensional adaptation of the invention to treads for tires of other categories (in particular for passenger vehicles, vans, etc.) while combining the different arrangements described previously.

I claim:

1. A tread for a tire having a preferred direction of travel, the tread comprising a plurality of tread pattern elements, each element being defined by cutouts of longitudinal and transverse general orientation, each element having an upper contact face and lateral faces extending in the direction of the thickness of the tread, the intersection of each lateral face with the upper contact face forming a ridge, the ridge which is first to come into contact with a road surface forming the leading edge of the element, the ridge which is last to emerge from the contact forming the trailing edge of the element; the plurality of tread pattern elements comprising a plurality of wells of section S and of depth H which open on to contact faces, each element being divided into a front section and a rear section by a virtual median plane Pv, said median plane Pv being perpendicular to the upper contact face of the element and to the longitudinal direction of the tread and passing through the center of mass G of the contact face of the element when new, the front section comprising the leading edge and the rear section comprising the trailing edge; wherein for each tread pattern element that is provided with at least one well, the volume Vpa of all the wells located in the front section of the tread pattern element is greater than the volume Vpf of all the wells located in the rear section of the tread pattern element when the tread is new.

2. A tread according to claim 1, wherein the wells have depths at least equal to 5 mm.

3. A tread according to claim 2, wherein the wells are arranged along at least two lines substantially parallel to the leading edge, the depths of the wells of two successive lines being different.

4. A tread according to claim 3, wherein the wells are arranged along at least two lines substantially parallel to the leading edge, the wells having sections S of between 0.2 mm² and 12 mm², the sections of the wells of two successive lines being different.

5. A tread according to claim 2, wherein the wells have their depths H which decrease gradually from a distance L from the leading edge towards the trailing edge.

6. A tread according to claim 1, wherein, on the contact face of at least one tread pattern element, the average number of wells per square centimeter is less than or equal to 15.

7. A tread according to claim 6, wherein, on the contact face of at least one tread pattern element, the number of wells per square centimeter decreases substantially from the leading edge towards the trailing edge.

8. A tread according to claim 1, wherein the axis of each well is substantially perpendicular to the contact face of each tread pattern element when new.

9. A tread according to claim 1, wherein at least one well of a tread pattern element has a main axis forming an angle other than zero with a direction perpendicular to the contact face of the tread pattern element.

10. A tread according to claim 1, wherein the main axis of at least one well of a tread pattern element has an inclination relative to a line perpendicular to the contact face of said element which is not constant in the thickness of the tread.

11. A tire having a tread which is provided with a tread pattern which imparts to the tire a preferred direction of travel, the tread comprising a plurality of tread pattern elements, each tread pattern element having an upper contact face and lateral faces extending in the direction of the thickness of the tread, the intersection of each lateral face with the upper face forming a ridge, the ridge which is first to come into contact with a road surface forming the leading edge of the element, the ridge which is last to emerge from the contact forming the trailing edge of the element; at least a plurality of tread pattern elements comprising a plurality of wells of section S and of depth H which open on to the contact face of said elements; each element being divided into a front section and a rear section by a virtual median plane Pv, said median plane Pv being perpendicular to the upper contact face of the element and to the longitudinal direction of the tread and passing through the center of mass G of the contact face of the element when new, the front section comprising the leading edge and the rear section comprising the trailing edge; the tread being characterized in that, when new and for each tread pattern element which is provided with wells, the wells have sections of between 0.2 mm² and 12 mm², and in that the volume Vpa of all the wells located in the front section of the tread pattern element is greater than the volume Vpf of all the wells located in the rear section of said element.

12. A tire according to claim 11, wherein at least the tread pattern elements located in the median region of its tread are provided with wells.
